(19) United States
(12) Patent Application Publication
(10) Pub. No.: US 2018/0072273 A1
(43) Pub. Date: Mar. 15, 2018

(54) MODIFIED WINDSHIELD WIPER BLADE HOLDER

(71) Applicants: Joey Huertas, Odessa, TX (US); Sylvia Reynolds, Odessa, TX (US)

(72) Inventors: Joey Huertas, Odessa, TX (US); Sylvia Reynolds, Odessa, TX (US)

(21) Appl. No.: 15/263,610

(22) Filed: Sep. 13, 2016

(51) Int. Cl. B60S 1/38

(52) U.S. Cl. CPC B60S 1/38; B60S 2001/3831; B60S 2001/3822

(57) ABSTRACT

A wiper blade assembly that includes: a wiper blade holder, where the holder is adapted to receive a wiper blade; a scrubber extending downward and a parallel to the wiper blade, where the scrubber and wiper blade are adapted to engage a windshield in unison during operation; and clips within the wiper blade holder to hold and support the wiper blade in position. The wiper blade holder includes an opening to receive the wiper blade, where the clips are with the opening and the opening may be adjustable in width. The wiper blade assembly also includes a wiper assembly, where the wiper assembly is adapted to receive the wiper blade holder.

### BACKGROUND OF THE INVENTION

### Field of Invention

The present invention relates to a modified windshield wiper blade holder with a scrubber attachment thereon.

### Description of Related Art

Windshield wipers are an automotive component that is used to clear the windshields for visibility. Windshield wipers are used during rain, snow or whenever moisture of some type is on the windshield. The windshield wiper blade is also used to clean the windshield with the use of cleaner fluid within the motor vehicle. For the most part windshield wipers are effective in clearing the view of the windshield during operation.

However in certain instances windshields may accumulate insects or other flying bugs during operation of the motor vehicle. The accumulation of this bug residue can be difficult to remove from windshields. Even with the use of the wiper fluid the blades may smear the bug residue over the windshield and therefore may obscure the view of the driver. The blade normally comes in contact with the windshield at a thin edge and therefore this facilitates the continued smearing of the bug residue. In order to remove this bug residue many times drivers must stop at a service facility to clean the windshield using a brush scrubber attachment or high-pressure water. It would be advantageous to have a scrubbing accessory that could be used in conjunction with the wiper blade to remove such bug residue.

### SUMMARY OF THE INVENTION

The present invention relates to a wiper blade assembly that includes: a wiper blade holder, where the holder is adapted to receive a wiper blade; a scrubber extending downward and a parallel to the wiper blade, where the scrubber and wiper blade are adapted to engage a windshield in unison during operation; and clips within the wiper blade holder to hold and support the wiper blade in position. The wiper blade holder includes an opening to receive the wiper blade, where the clips are with the opening and the opening may be adjustable in width. The wiper blade assembly also includes a wiper assembly, where the wiper assembly is adapted to receive the wiper blade holder.

### BRIEF DESCRIPTION OF DRAWINGS

FIG. 1 depicts a windshield wiper blade used in a blade holder of the prior art.

FIG. 2 depicts a modified blade holder in accordance with the present invention.

FIG. 3 depicts use of the modified blade holder in conjunction with a blade wiper assembly in accordance with the present invention.

### DETAILED DESCRIPTION

The present invention relates to a windshield wiper blade holder that is modified to include a scrubber. The scrubber is placed parallel to the wiper blade and provides an additional device to transfer over the windshield during operation of the blade. The blade holder according to present invention provides an opening for the insertion of a conventional wiper blade where the wiper blade is aligned with a scrubber. Therefore, the scrubber and blade both contact the windshield during operation with blade holder place upon a wiper assembly arm for attachment similar to a traditional blade holder.

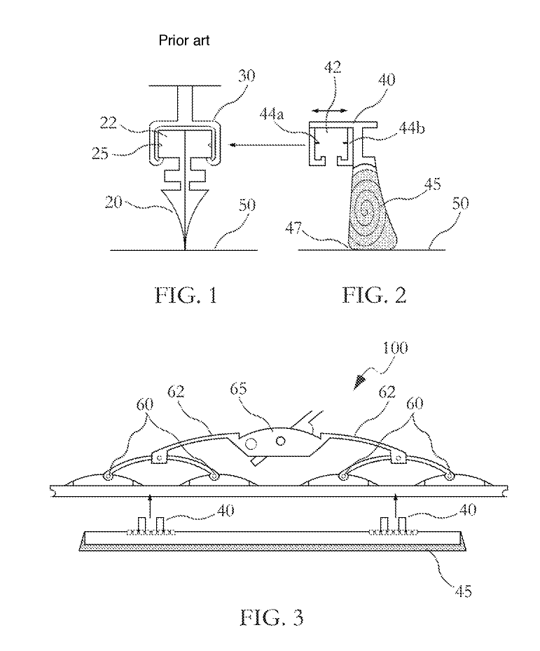

In reference FIG. 1, a blade holder 30 of the prior art is depicted. The blade holder 30 includes an opening that allows for the insertion of a wiper blade 20. A blade base 22 inserts into the holder 30 and allows the extension of the blade 20 for application over a windshield 50. Clips 25 are on the inside of the blade holder 30 to hold the base 22 of the wiper blade 20 into place.

FIG. 2 shows a blade holder modification 40 according to the present invention. Blade holder 40 preferably is adjustable in width as noted in FIG. 2. This blade holder 40 includes an opening 42 with clips 44a, 44b. Clips 44a, 44b allow for the insertion of a traditional wiper blade so that it is aligned with a scrubber 45 shown in FIG. 2. Scrubber 45 extends downward from the blade holder 40 and includes a scrubber edge 47 for contact with the windshield.

FIG. 3 depicts attachment of the scrubber 45 to a wiper assembly 100. Wiper assembly 100 includes braces 62 extending from each side of an arm attachment 65. The braces 62 include support claws 60 on each side of the wiper assembly 100. The support claws 60 receive the blade holder 40 as shown in FIG. 3. As a result, the present invention provides a holder that adds cleaning strength to a typical windshield wiper blade and ensures the cleaning of the windshield during appropriate situations. The instant invention has been shown and described in what it considers to be the most practical and preferred embodiments. It is recognized, however, that departures may be made there from within the scope of the invention and that obvious modifications will occur to a person skilled in the art.

1. A wiper blade assembly comprising:
a. a wiper blade holder, where the holder is adapted to receive a wiper blade, where the wiper blade holder includes an opening to receive the wiper blade, wherein said opening is adjustable in width;
b. a scrubber extending downward and a parallel to the wiper blade, where the scrubber and wiper blade are adapted to engage a windshield in unison during operation, further wherein the scrubber includes a flat surface and said flat surface contacts a windshield surface during use, further said scrubber has a first width at a proximal and a second width at a distal end where the distal end includes the flat surface, wherein said first width is less than the second width; and
c. clips within the opening of the wiper blade holder to hold and support the wiper blade in position.

2. (canceled)

3. (canceled)

4. (canceled)

5. The wiper blade assembly according to claim 1, further including a wiper assembly, where the wiper assembly is adapted to receive the wiper blade holder.

6. The wiper blade assembly according to claim 5, where the wiper assembly includes an arm attachment with braces extending from each side of the arm attachment.

7. The wiper blade assembly according to claim 6, where the wiper assembly further includes support claws attached to the braces, where the support claws are adapted to receive the wiper blade holder.
